(19) United States
(12) Patent Application Publication
(10) Pub. No.: US 2025/0094249 A1
(43) Pub. Date: Mar. 20, 2025

(54) Intelligent Event Management

(71) Applicant: Oracle International Corporation, Redwood Shores, CA (US)

(72) Inventors: Manas Goswami, San Ramon, CA (US); Ana Maria Hernandez McCollum, Belmont, CA (US); Ze Tian Ding, Dublin, CA (US); Ganesh Kadoor Prasad, Bangalore (IN); Desiree Oduro Abrokwa, San Francisco, CA (US)

(73) Assignee: Oracle International Corporation, Redwood Shores, CA (US)

(21) Appl. No.: 18/886,868

(22) Filed: Sep. 16, 2024

Related U.S. Application Data
(60) Provisional application No. 63/583,300, filed on Sep. 17, 2023.

(51) Int. Cl. G06F 9/54; G06F 9/451

(52) U.S. Cl. CPC G06F 9/542; G06F 9/451

(57) ABSTRACT

Techniques for managing events that record occurrences in a computing environment are disclosed. The system identifies events, and the system applies event processing mechanisms to the events. The event processing mechanisms generate incidents to represent the events. The system presents an interface that demonstrates how the events are mapped to the incidents. A user may interact with the interface to modify the event processing mechanisms and/or define new event processing mechanisms. Furthermore, the system may identify a group of uncompressed events, and the system may determine a candidate compression policy that would generate a single incident to represent the group of uncompressed events. The system may generate the candidate compression policy by applying a trained machine learning model to the group of uncompressed events. The system may simulate applying the candidate compression policy, and the system may present the results of the simulated application to the user on the interface.

### INCORPORATION BY REFERENCE; DISCLAIMER

The following applications is hereby incorporated by reference: Application No. 63/583,300, filed Sep. 17, 2023, that is hereby incorporated by reference. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to managing events occurring in a computing environment.

### BACKGROUND

An issue that is experienced by a computing environment may manifest itself as an abnormality that occurs on a component of the computing environment. An abnormality associated with an issue may occur on a software component, a hardware component, and/or a component that combines software and hardware. An issue experienced by a computing environment is associated with a single abnormality, or the issue is associated with multiple abnormalities. If an issue experienced by a computing environment is associated with multiple abnormalities, the abnormalities occur on a single component, or the abnormalities occur on multiple components. Due to dependencies between components of a computing environment, one abnormality occurring on one component may result in another abnormality occurring on another component. Note that even a single issue experienced by a computing environment may be associated with numerous abnormalities that occur on various components of the computing environment. It should also be noted that any two abnormalities associated with a given issue may differ greatly with respect to type, severity, frequency, timing, and other characteristics.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for managing events in accordance with one or more embodiments;

FIG. 2 illustrates an example set of operations for processing events in accordance with one or more embodiments;

FIG. 3 illustrates an example set of operations for formulating event processing mechanisms in accordance with one or more embodiments;

FIG. 4 illustrates an example set of operations for training machine learning model(s) to formulate event processing mechanisms in accordance with one or more embodiments;

FIG. 5 illustrates an example visualization of event processing in accordance with an example embodiment;

FIG. 6 illustrates an example visualization of event compression in accordance with an example embodiment;

FIG. 7 illustrates an example dashboard for a candidate compression policy analysis in accordance with an example embodiment; and

FIG. 8 illustrates a block diagram of a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. EVENT MANAGEMENT SYSTEM
3. PROCESSING EVENTS
4. FORMULATING EVENT PROCESSING MECHANISMS
5. MACHINE LEARNING FOR EVENT MANAGEMENT
6. EXAMPLE EMBODIMENT
   6.1 EXAMPLE VISUALIZATION OF EVENT PROCESSING
   6.2 EXAMPLE VISUALIZATION OF EVENT COMPRESSION
   6.3 EXAMPLE DASHBOARD FOR A COMPRESSION POLICY ANALYSIS
   6.4 EXAMPLE IMPLEMENTATIONS
7. COMPUTER NETWORKS AND CLOUD NETWORKS
8. MICROSERVICE APPLICATIONS
   8.1 TRIGGERS
   8.2 ACTIONS
9. HARDWARE OVERVIEW
10. MISCELLANEOUS; EXTENSIONS

### 1. GENERAL OVERVIEW

One or more embodiments display interface elements, on a Graphical User Interface (GUI), that visually links a cluster of events with a single incident that represents the cluster of events. The system applies compression policies to a group of uncompressed events to identify a cluster of events that may be compressed and represented by a single incident. The system displays both the initial group of uncompressed events and the incidents that are generated by applying the compression policies to the group of uncompressed events. Furthermore, the system displays interface elements that link a particular cluster of events with a single incident that represents the particular cluster of events.

One or more embodiments provide an interface that a user may engage with to (a) learn of significant events, (b) view representations of events at multiple levels of abstraction, (c) compress and/or decompress events, (d) analyze the performance of event processing mechanisms, (e) modify event processing mechanisms, (f) generate new event processing mechanisms, (g) receive suggestions regarding event processing mechanisms, and/or (h) otherwise manage events. To provide the interface, the system detects occurrences on components of a computing environment associated with the user, and the system generates events to describe low-level details of the occurrences. Note that, in some cases, the low-level details of any given occurrence may be extensive, and the system may spawn a large number of events in event a short period of time. Thus, the system may apply event processing mechanisms to events to generate more palatable abstractions of the events that can be presented to the user. While applying event processing mechanisms to events, the system may (a) generate incidents to represent events, (b) generate problems to represent incidents, (c) generate notifications of events, incidents, and/or problems, (d) perform diagnostics, (e) perform corrective actions, and/or (f) perform various other operations.

One or more embodiments communicate an issue experienced by a computing environment at multiple levels of abstraction by presenting visualization(s) that include (a) interface elements representing events, (b) interface elements representing incidents, (c) interface elements representing problems, (d) interface elements representing mappings between events, incidents, and problems, and/or (e) other interface elements. In an example, a low-level representation of an issue is presented by interface elements representing events, a higher-level representation of the issue is presented by interface elements representing incidents, and a highest-level representation of the issue is presented by an interface element representing a problem.

One or more embodiments generate and/or apply an event processing mechanism based on root cause analysis. For example, by applying root cause analysis, the system may identify (a) events corresponding to symptoms of an issue associated with a computing environment and (b) an event corresponding to the cause of the issue associated with the computing environment. In this example, the system (a) compresses the events corresponding to symptoms and (b) refrains from compressing the event corresponding to the cause. Note that, in this example, resolving the issue might merely require the system to notify a user of the event corresponding to the cause. Furthermore, notifying the user of the events corresponding to a symptom might result in the event corresponding to the cause escaping the user's attention.

One or more embodiments apply a decompression policy to (a) prevent an event from being compressed into an incident and/or (b) remove an event from a cluster of events compressed into an incident. By applying a decompression policy, the system may avoid an event having individual significance from being lost to a user's attention as a consequence of that event being compressed into an incident.

One or more embodiments generate a new event processing mechanism by applying a trained machine learning model to a group of events. In an example, the system uses training data to teach a machine learning model to formulate a compression policy. An example set of training data defines an association between (a) a cluster of uncompressed events and (b) an appropriate compression policy for compressing those events into an incident. Having trained the machine learning model, the system applies the machine learning model to uncompressed events to formulate a new compression policy in this example.

One or more embodiments generate and/or modify an event processing mechanism based on a user interaction(s) with interface elements representing events, incidents, and/or problems. As an example, assume that the interface presents a visualization illustrating two events that are respectively mapped to two incidents, and further assume that the user manipulates the visualization, so the two events are remapped to a single incident. In this example, the system formulates a new compression policy that would compress the two events into a single incident in the future.

One or more embodiments provide an interface that may be employed by a user to (a) analyze the performance of a candidate event processing mechanism, (b) modify the candidate event processing mechanism, and/or (c) evaluate how that modification impacts the candidate event processing mechanism's performance. As an example, assume that the system applies a trained machine learning model to generate a candidate compression policy. In this example, the system simulates applying the candidate compression policy to a data corpus of events that previously occurred in a computing environment. Based on the simulated application of this example, the system generates a visualization that demonstrates the performance of the candidate compression policy. In particular, the visualization includes (a) interface elements representing incidents that are generated without the candidate compression policy, (b) interface elements representing incidents that are generated with the candidate compression policy, and (c) interface elements representing the events that are compressed by the candidate compression policy. For the purposes of this example, assume that the user manipulates an interface element representing a particular event to remove the particular event from a cluster of events that are compressed into a particular incident by the candidate compression policy during the simulated application. In response, the system of this example may (a) modify the candidate compression policy such that the particular event is not compressed into the particular incident during a second simulated application of the candidate compression policy, (b) generate or update a decompression policy to prevent the particular event being compressed into the particular incident during a second simulated application of the candidate compression policy, and/or (c) generate or modify other event processing mechanisms. In this example, the system subsequently performs a second simulated application of the candidate compression policy, and the system updates the visualization presented to the user to reflect the candidate compression policy's performance during the second simulated application. Furthermore, the system of this example may process that interaction with the user to generate feedback for the machine learning model, and the system may further train the machine learning model based on the feedback.

One or more embodiments described in this Specification and/or recited in the claims may not be included in this General Overview section.

### 2. EVENT MANAGEMENT SYSTEM

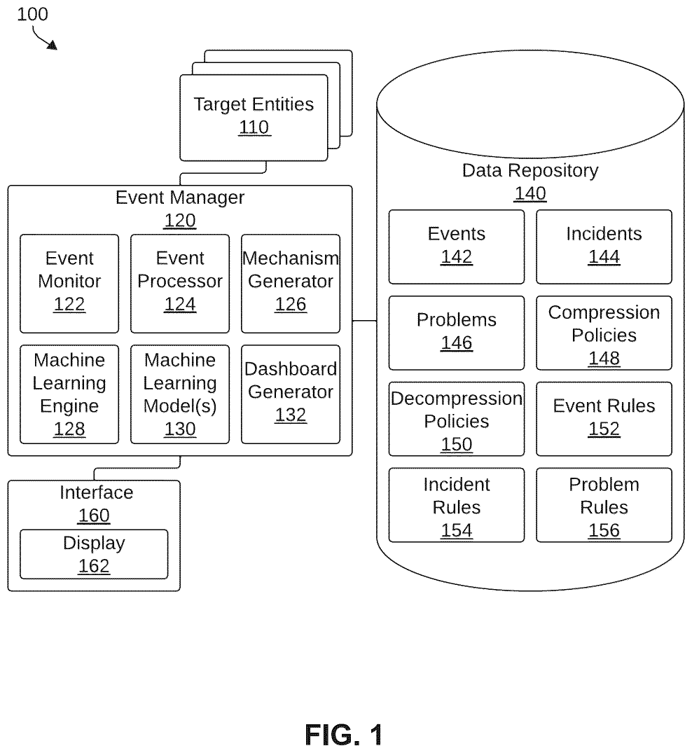

FIG. 1 illustrates a system 100 for managing events in accordance with one or more embodiments. As illustrated in FIG. 1, system 100 may include target entities 110, event manager 120, data repository 140, and interface 160. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

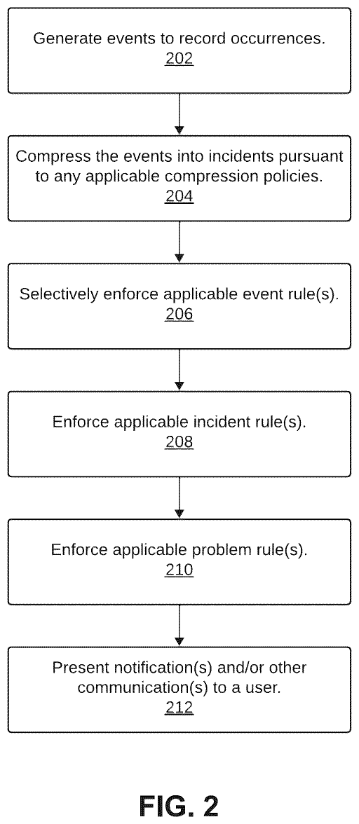

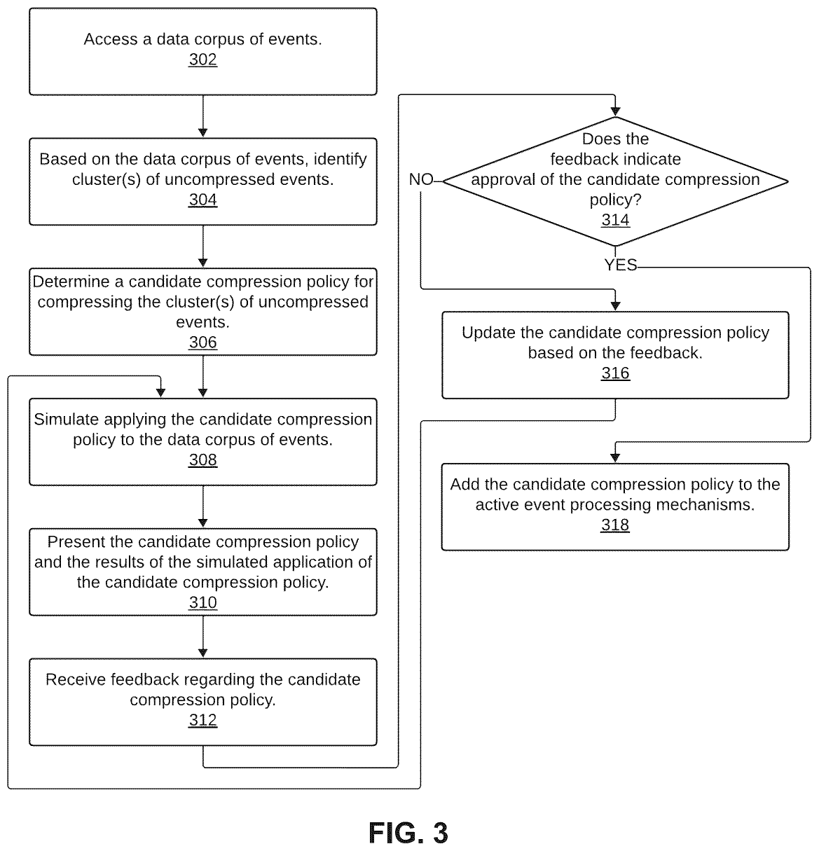

In an embodiment, system 100 refers to hardware and/or software configured to perform operations described herein for processing events and/or formulating event processing mechanisms. Examples of operations for processing events are described below with reference to FIG. 2. Examples of operations for formulating event processing mechanisms are described below with reference to FIG. 3.

In an embodiment, target entities 110 are components of a computing environment that are monitored for occurrences of potential significance. Target entities 110 may or may not be located at the same physical site. Target entities 110 may be implemented on the same computing system, and/or target entities 110 may be implemented on separate computing systems. Target entities 110 are communicatively coupled to other component(s) of system 100 via physical link(s), and/or target entities 110 are communicatively coupled to other component(s) of system 100 via wireless link(s).

In an embodiment, a target entity 110 is characterized by attribute(s). As used herein, the term “target attribute” refers to an attribute of a target entity 110. Example target attributes include a name (referred to as a “target name”), a type (referred to as a “target type”), an operational status, a location (referred to as a “target location”), a version, a configuration, a role, an ownership, dependencies, a group, custom attributes, and/or other attributes. Note that a computing environment may include various differing components. Thus, target entities 110 may include various target types. Example target types include a database target, a middleware target, an application target, a host target, a listener target, a storage target, a network target, a cloud target, a custom target, and others.

In an embodiment, event manager 120 is software and/or hardware configured to manage events. As illustrated in FIG. 1, event manager 120 may include event monitor 122, event processor 124, mechanism generator 126, machine learning engine 128, machine learning model(s) 130, and/or dashboard generator 132. In an embodiment, event manager 120 includes more or fewer components than the components illustrated in FIG. 1. Components of event manager 120 may be implemented on the same computing system, and/or components of event manager 120 may be implemented on separate computing systems.

In an embodiment, event monitor 122 is software and/or hardware configured to monitor target entities 110. In particular, event monitor 122 is configured to detect occurrences on target entities 110, and event monitor 122 is further configured to generate events 142 that describe the occurrences on the target entities 110. Event monitor 122 may be configured to generate an event 142 for any manner of occurrence on a target entity 110. Event monitor 122 is generally configured to generate events 142 for abnormal occurrences on target entities 110.

In an embodiment, event processor 124 is hardware and/or software configured to process events 142. To this end, event processor 124 applies event processing mechanisms to events 142. Examples of event processing mechanisms include compression policies 148, decompression policies 150, event rules 152, incident rules 154, problem rules 156, and others.

In an embodiment, mechanism generator 126 is software and/or hardware configured to generate event processing mechanisms. In particular, mechanism generator 126 is configured to formulate compression policies 148, decompression policies 150, event rules 152, incident rules 154, problem rules 156, and/or other event processing mechanisms. Mechanism generator 126 is configured to formulate an event processing mechanism based on root cause analysis, by applying machine learning model(s) 130, and/or by other means. Mechanism generator 126 is configured to generate an event processing mechanism autonomously, and/or mechanism generator 126 is configured to generate an event processing mechanism based on user input. Mechanism generator 126 may obtain user input via interface 160.

In an embodiment, machine learning engine 128 is one or more machine learning algorithms that can be iterated to train a target model f that best maps a set of input variables to an output variable. In particular, machine learning engine 128 is configured to generate and/or train machine learning model(s) 130.

In an embodiment, a machine learning algorithm is an algorithm that can be iterated to train a target model f that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, that in turn updates the target model f.

In an embodiment, machine learning engine 128 generates a target model f such that the target model f best fits the datasets of training data to the labels of the training data. Additionally, or alternatively, machine learning engine 128 generates a target model f such that when the target model f is applied to the datasets of the training data, a maximum number of results determined by the target model f matches the labels of the training data. Different target models be generated based on different machine learning algorithms and/or different sets of training data.

In an embodiment, a machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, machine learning model(s) 130 are trained by machine learning engine 128 to generate compression policies 148, and/or machine learning model(s) 130 are trained by machine learning engine 128 to generate decompression policies 150. Additionally, or alternatively, machine learning model(s) 130 are trained by machine learning engine 128 to generate event rules 152, incident rules 154, problem rules 156, and/or other event processing mechanisms.

In an embodiment, dashboard generator 132 is software and/or hardware configured to generate communications that can be presented to a user. Example communications that may be generated by dashboard generator 132 include visualizations, metrics, natural language communications, and others. Examples visualizations that may be generated by dashboard generator 132 include charts, graphs, dashboards, tables, diagrams, pictures, timelines, and others.

In an embodiment, a data repository 140 is any type of storage unit and/or device (e.g., a file system, database, collection of tables, or any other storage mechanism) for storing data. Further, a data repository 140 may include multiple different storage units and/or devices. The multiple different storage units and/or devices may or may not be of the same type or located at the same physical site. Furthermore, a data repository 140 may be implemented or executed on the same computing system as other components of system 100. Additionally, or alternatively, a data repository 140 may be implemented or executed on a computing system separate from other components of system 100. The data repository 140 may be communicatively coupled to other component(s) of system 100 via physical link(s), and/or data repository 140 may be communicatively coupled to other component(s) of system 100 via wireless link(s).

As illustrated in FIG. 1, data repository 140 may store events 142, incidents 144, problems 146, compression policies 148, decompression policies 150, event rules 152, incident rules 154, problem rules 156, and/or other information. Information describing events 142, incidents 144, problems 146, compression policies 148, decompression policies 150, event rules 152, incident rules 154, and problem rules 156 may be implemented across any of the components within the system 100. However, this information is illustrated within the data repository 140 for purposes of clarity and explanation.

In an embodiment, events 142 record occurrences on target entities 110. An event 142 may describe any occurrence on a target entity 110. Events 142 generally describe occurrences on target entities that are outside of the target entities' 110 normal operation conditions (i.e., abnormal occurrences). An example event 142 conveys low-level details describing an abnormal occurrence. The example event 142 may include as many details as may be required by a user for a myriad of purposes.

In an embodiment, an event 142 is characterized by attribute(s). An attribute of an event 142 is referred to herein as an “event attribute.” Example event attributes that may characterize an event 142 include the following: a type, a severity, a message, a timestamp, a category, a causal analysis update, custom attributes, and others. Example event types include a metric alert, a metric evaluation error, a compliance standard score violation, a job status change, a compliance standard rule violation, a service level agreement (SLA) alert, and others. Example event severities are informational, clear, advisory, warning, critical, fatal, and others. Note that an event 142 may also describe target attributes of the target entity 110 that the event 142 occurs on. For example, an event 142 may describe a target name, a target type, and other target attributes.

In an embodiment, an event 142 is a causal event, and/or the event 142 is a symptom event. As used herein, the term “causal event” refers to an event 142 representing an occurrence that causes another occurrence at least in part, and the term “symptom event” refers to an event 142 representing an occurrence that is a consequence of another occurrence at least in part. As an example, consider multiple applications that are running on a virtual machine, and assume that the multiple applications and the virtual machine are target entities 110. For the purposes of this example, further assume that the virtual machine fails; consequently, the applications running on the virtual machine also fails. Therefore, in this example, an event 142 is generated for the virtual machine failure, and events 142 are generated for the application failures. In this example, the event corresponding to the virtual machine failure is a causal event, and the events corresponding to the application failures are symptom events.

In an embodiment, incidents 144 are higher-level representations of events 142. An incident 144 represents a single event 142, or an incident 144 represents multiple events 142. An incident 144 is associated with a single target entity 110, or an incident 144 is associated with multiple target entities 110. An example incident 144 represents a group of related events 142 that are a manifestation of a broader issue that is being experienced by a computing environment.

In an embodiment, an incident 144 is characterized by attribute(s). An attribute of an incident 144 is referred to herein as a “incident attribute.” Example incident attributes that may characterize an incident 144 include an ID, a name, a severity, a status, a creation time, a last updated time, owner/assignee, priority, custom attributes, and others. Note that an incident 144 may further describe event attributes and/or target attributes (e.g., a target name, a target type, etc.).

In an embodiment, problems 146 are higher-level representations of incidents 144. A problem 146 represents a single incident 144, or the problem 146 represents multiple incidents 144. A problem 146 is associated with a single target entity 110, or the problem 146 is associated with multiple target entities 110. An example problem 146 represents a group of related incidents that are a manifestation of a broader issue that is being experienced by a computing environment.

In an embodiment, a problem 146 is characterized by attribute(s). An attribute of a problem 146 is referred to herein as a “problem attribute.” Example problem attributes that may characterize a problem 146 include a severity, a type, an impact score, and others. Note that the problem 146 may further describe incident attributes, event attributes, and/or target attributes.

In an embodiment, compression policies 148 define criteria for compressing events 142 into incidents 144. Additionally, or alternatively, compression policies 148 define criteria for compressing incidents 144 into problems 146. As used herein, the term “compression” may refer to (a) generating an incident 144 to represent multiple events 142 and/or (b) mapping an event 142 to an incident 144 that already represents at least one other event 142. Furthermore, the term “compression” may also refer to (a) generating a problem 146 to represent multiple incidents 144 and/or (b) mapping an incident 144 to a problem 146 that already represents at least one other incident 144. Compression policies 148 may include standard out-of-the-box compression policies 148, and/or compression polices 148 may include custom compression policies 148. A custom compression policy 148 is a compression policy 148 that is created by mechanism generator 126 and/or a user.

In an embodiment, a compression policy 148 defines a criterion or criteria for compressing specific events 142, and/or the compression policy 148 defines a criterion or criteria for compressing specific incidents 144. The compression policy 148 may further define the manner that the specific events 142 and/or incidents 144 should be compressed. The compression policy may be defined in terms of incident attributes, event attributes, target attributes, and/or other characteristics.

In an embodiment, decompression policies 150 define criteria for decompressing events 142 from incidents 144. Additionally, or alternatively, decompression policies 150 define criteria for decompressing incident 144 from problems 146. As used herein, the term “decompression” may refer to (a) removing an event 142 from an incident 144 and/or (b) preventing the event 142 from being added to an incident 144. Furthermore, the term “decompression” may also refer to (a) removing an incident 144 from a problem 146 and/or (b) preventing an incident 144 from being added to a problem 146. Decompression policies 150 may include standard out-of-the-box decompression policies 150, and/or decompression policies 150 may include custom decompression policies 150. A custom decompression policy 150 is a decompression policy 150 that is created by mechanism generator 126 and/or a user.

In an embodiment, a decompression policy 150 defines a criterion or criteria for decompressing specific events 142, and/or the decompression policy 150 defines a criterion or criteria for decompressing specific incidents 144. The decompression policy 150 may further define the manner that the specific event(s) 142 and/or specific incidents 144 should be decompressed. The decompression policy 150 may be defined in terms of incident attributes, event attributes, target attributes, and/or other characteristics.

In an embodiment, compression policies 148 and/or decompression policies 150 are assigned relative levels of priority. A level of priority assigned to a compression policy 148 or a decompression policy 150 may dictate if and/or when the compression policy 148 or the decompression policy 150 is applied to events 142.

In an embodiment, event rules 152 define operations that are to be completed in response to specific events 142. Event rules 152 may be defined in terms of event attributes, target attributes, and/or other characteristics. An event rule 152 may be formulated to require the performance of any operation that is within the capabilities of system 100. An example event rule 152 dictates that an incident 144 is created to represent an event 142, and/or the example event rule 152 dictates that a notification is generated for the event 142. Note that event rules 152, like compression policies 148, may specify conditions for compressing events 142. Further note that event rules 152, like decompression policies 150, may specify conditions for decompressing events 142. Event rules 152 may be organized into event rule sets. An event rule set is associated with a single target entity 110, or an event rule set is associated with multiple target entities 110.

In an embodiment, incident rules 154 define operations that are to be completed in response to specific incidents 144. Incident rules 154 may be defined in terms of incident attributes, event attributes, target attributes, and/or other characteristics. An incident rule 154 may be formulated to require the performance of any operation that is within the capabilities of system 100. An example incident rule 154 dictates that a problem 146 is created to represent an incident 144, and/or the example incident rule 154 dictates that a notification is generated for the incident 144. Incident rules 154 may be organized into incident rule sets. An incident rule set is associated with a single target entity 110, or an incident rule set is associated with multiple target entities 110.

In an embodiment, problem rules 156 define operations that are to be completed in response to specific problems 146. Problem rules 156 may be defined in terms of problem attributes, incident attributes, event attributes, target attributes, and/or other characteristics. A problem rule 156 may be formulated to require the performance of any operation that is within the capabilities of system 100. An example problem rule 156 dictates that a notification is generated for a problem 146. Problem rules 156 may be organized into problem rule sets.

In one or more embodiments, interface 160 refers to hardware and/or software configured to facilitate communications between a user and event manager 120. Interface 160 renders user interface elements and receives input via user interface elements. Examples of interfaces include a graphical user interface (GUI), a command line interface (CLI), a haptic interface, and a voice command interface. Examples of user interface elements include shapes, lines, colors, checkboxes, radio buttons, dropdown lists, list boxes, buttons, toggles, text fields, date and time selectors, command lines, sliders, pages, forms, and others. Interface 160 is communicatively coupled to other component(s) of system 100 via physical link(s), and/or interface 160 communicatively coupled to other component(s) of system 100 via wireless link(s).

In an embodiment, different components of interface 160 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 160 is specified in one or more other languages, such as Java, C, or C++.

In an embodiment, interface 160 is associated with one or more components for presenting information to a user such as display 162. Display 162 is implemented on a digital device or otherwise. Display 162 may be, for example, a visual device, an audio device, an audiovisual device, etc. Examples of visual devices include monitors, televisions, projectors, and others.

In an embodiment, interface 160 is configured to communicate the state of a computing environment in terms of events 142, incidents 144, problems 146, and other information. Interface 160 is configured to present communications generated by dashboard generator 132. For instance, interface 160 is configured to present visualizations, metrics, natural language communications, and other communications. In an example, interface 160 presents (a) a visualization of events 142 that serves as a low-level representation of issues experienced by target entities 110, (b) a visualization of incidents 144 that serves as a higher-level representation of issues experienced by target entities 110, and/or (c) a visualization of problems 146 that serves as a highest-level representation of issues experience by target entities 110. Interface 160 is further configured to present notifications to a user that are generated by event processing mechanisms (e.g., event rules 152, incident rules 154, problem rules 156, etc.).

In an embodiment, interface 160 is configured to receive input from a user. Interface 160 may include various sensors for capture user input. For example, interface 160 may include tactile sensors, audio sensors, visual sensors, thermal sensors, and/or other sensors. A user may interact with interface 160 to create and/or modify compression policies 148, decompression policies 150, event rules 152, incident rules 154, problem rules 156, and/or other mechanisms for processing events 142. Furthermore, user input received by interface 160 may be utilized as feedback for machine learning model(s) 130.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

Additional embodiments and/or examples relating to computer networks are described below in Section 7, titled “Computer Networks and Cloud Networks.”

### 3. PROCESSING EVENTS

FIG. 2 illustrates an example set of operations for processing events in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, the system generates events to record occurrences observed by the system (Operation 202). The events represent occurrences on a single target entity, or the events represent occurrences on multiple target entities. The attributes of any two events may differ. For instance, the events may include various types of events (e.g., metric alerts, compliance violations, job events, etc.), and/or the events may include events of differing severities (e.g., warning, critical, fatal, etc.). Furthermore, if the events occur on multiple target entities, the multiple target entities may be associated with differing target attributes. However, at least a subset of the events are associated with the same cause. A subset of events may be associated with the same cause if those events (a) have identical, similar, or related attributes, (b) occur on the same target entity, (c) occur on related target entities, (d) occur in close temporal proximity, and/or (e) are otherwise related.

In an embodiment, the system compresses events into incidents pursuant to any applicable compression policies (Operation 204). If a compression policy is applicable to an event (i.e., the criteria defined by the compression policy is satisfied), the system generates a new incident to represent that event and at least one other event, or the system organizes that event into an existing incident that is already representing at least one other event. For any given event, there is (a) no applicable compression policy, (b) a single applicable compression policy, or (c) multiple applicable compression policies. If there are multiple compression policies that are applicable to the events, the system may determine what applicable compression policies to apply, and/or the system may determine an appropriate sequence for enforcing the applicable compression polices.

Recall that compression policies are assigned relative levels of priority in an embodiment. Thus, if there are multiple compression policies applicable to the events, the system may enforce the multiple compression policies in a sequence corresponding to the compression policies' relative levels of priority. For example, the system may apply one compression policy instead of an alternative compression policy based on the one compression policy having been assigned a higher level of priority than the alternative compression policy. In another example, the system applies one compression policy before another compression policy because the one compression policy has a higher level of priority than the other compression policy.

While applying a compression policy, the system, according to an embodiment, selectively compresses events based on root cause analysis. The root cause analysis prevents the system from compressing events having individual significance that might be overlooked if those events are compressed. For instance, the root cause analysis enables the system to distinguish between symptom events and causal events. Accordingly, the system compresses symptom events, and/or the system refrains from compressing causal events. Furthermore, if an event is considered neither a symptom event nor a causal event, the system generally refrains from compressing that event. As an example, consider a server hosting hundreds of applications, and assume that a server outage occurs. In this example, an event is generated for the server outage, and events are also generated for the failures of the individual application hosted by the server. Note that resolving the server outage and the application failures in this example merely requires that a user be notified of the server outage event. Moreover, failing to compress the events corresponding to the application failure in this example might result in the server outage event evading a user's attention. In this example, the system determines that (a) the application failure events are symptom events, and (b) the server outage event is a causal event. In response, the system compresses the application failure events, and the system refrains from compressing the server failure event. As another example, further consider a server hosting hundreds of applications, and assume that a small number of applications fail over an extended period of time. In this example, root cause analysis by the system does not lead to the conclusion that the application failures result from the same cause. Accordingly, the system refrains from compressing the application failure events in this example.

The system, according to an embodiment, decompresses event(s) according to any applicable decompression policies. If a decompression policy is applicable to an event, the system removes that event from an incident, and/or the system prevents that event from being compressed into an incident.

In an embodiment, the system enforces event rule(s) that are applicable to the events (Operation 206). While enforcing an event rule on an event, the system may generate an incident to represent the event, generate a notification for the event, generate other communications, perform corrective actions, perform further analysis, and/or perform various other operations. Recall that event rules may be defined to require the performance of any operation that is within the capabilities of the system. Generally, the event rules will dictate that the system creates incidents for any events that are not already represented by an existing incident. Further recall that event rules, like compression policies, may provide for the compression of multiple events into a single incident.

The system, according to an embodiment, selectively refrains from enforcing applicable event rule(s). In general, if a compression policy has already mapped an event to an incident, the system does not enforce an event rule that would create an additional incident to represent that event. However, note that there may not be an applicable compression policy for a given event. Further note that an event rule does not necessarily generate an incident. If an event rule does not generate an incident, the system may apply that event rule to an event without regard to whether or not that event has already been organized into an incident.

In an embodiment, the system enforces any applicable incident rule(s) (Operation 208). While enforcing an incident rule on an incident, the system may generate a problem to represent the incident, generate a notification for the incident, generate other communications, perform corrective actions, engage in further analysis of the incident, and/or perform various other operations. Recall that incident rules may be defined to require the performance of any operation that is within the capabilities of the system. Incident rules are applied to incidents generated by compression policies, event rules, and/or other event processing mechanisms.

In an embodiment, the system enforces any applicable problem rule(s) (Operation 210). While enforcing a problem rule on a problem, the system may generate a notification for the problem, generate other communications, perform corrective actions, engage in further analysis of the problem, and/or perform various other actions. Recall that problem rules may be defined to require the performance of any operation that is within the capabilities of the system.

In an embodiment, the system presents notification(s) to a user (Operation 212). In particular, the system presents any notifications that are generated by the applicable compression policies, event rules, incident rules, problem rules, and/or other event processing mechanism mechanisms. The system presents the notifications to the user via an interface (e.g., a GUI, an API, a CLI, etc.).

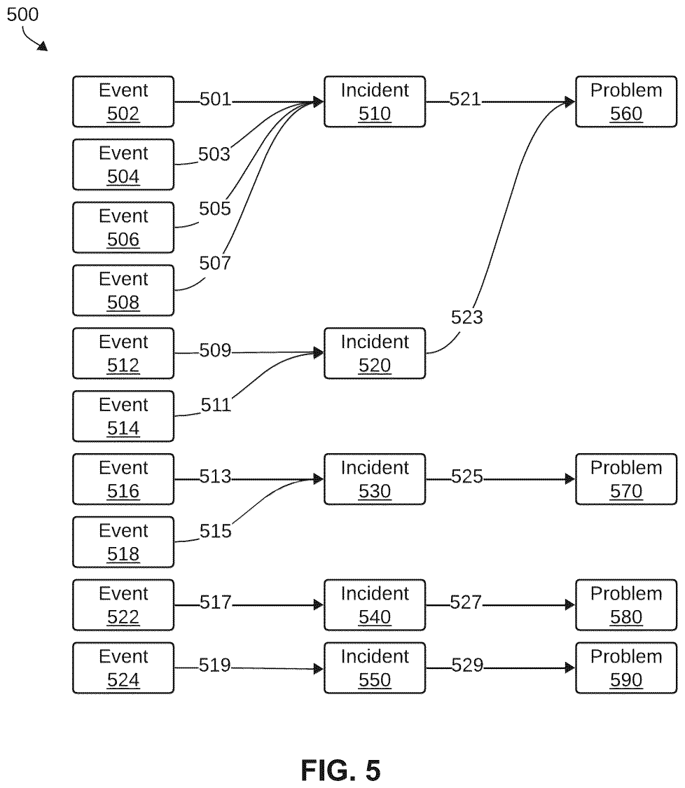

The system, according to an embodiment, notifies a user of event(s), incident(s), and/or problem(s) by presenting a visualization of the event(s), incident(s), and/or problem(s). The system presents a single visualization, or the system presents multiple visualizations. An example visualization of events, incidents, and problems is described below with reference to FIG. 5.

### 4. FORMULATING EVENT PROCESSING MECHANISMS

FIG. 3 illustrates an example set of operations for formulating new event processing mechanisms in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments. The operations illustrated in FIG. 3 are described as being executed to generate a single event processing mechanism; however, it should be understood that the operations illustrated in FIG. 3 may be executed to generate multiple event processing mechanisms concurrently.

For the purposes of clarity and understanding, the remainder of the discussion in this Section 4 shall assume that the new event processing mechanism that is being formulated is a candidate compression policy. However, it should be understood that the techniques described within this Section 4 are equally applicable to other event processing mechanisms, such as decompression policies, event rules, incident rules, problem rules, and others.

In an embodiment, the system compiles a data corpus of events that are to be used for generating the candidate compression policy (Operation 302). The data corpus of events may include newly created events, historical events, simulated events, and/or other events. As an example, assume that the system is attempting to tailor the candidate compression policy to a particular user. In this example, the system identifies target entities that are associated with the particular user, and the system compiles the data corpus of events by accessing events that have occurred on those target entities over a set period of time.

In an embodiment, the system identifies cluster(s) of uncompressed events within the data corpus of events (Operation 304). In particular, the system identifies clusters of uncompressed events that are related to one another. Note that a cluster of related uncompressed events represents a potential target for the candidate compression policy. Example clusters of uncompressed events that may be identified by the system include a cluster of identical events, a cluster of similar events, a cluster of events occurring on the same target entity, a cluster of events occurring on related target entities, and/or a cluster of events that are otherwise related. The system may identify relationships between events based on event attributes, target attributes, and/or other characteristics.

In an embodiment, the system formulates the candidate compression policy to target a cluster of uncompressed events (Operation 306). The system formulates the candidate compression policy based on attributes of events in the cluster of uncompressed events, attributes of any target entities that the cluster of uncompressed events occurs on, user characteristics, user input, and/or other information.

The system, according to an embodiment, determines the candidate compression policy based on root cause analysis. As an example, assume that the cluster of uncompressed events corresponds to a failure of a container database (CDB) that contains one hundred pluggable databases (PDBs). In this example, the cluster of events includes one event describing the failure of the CDB, and the cluster of events includes one hundred events describing the failures of the PDBs. By applying root cause analysis to the one hundred and one events, the system determines that the CDB failure is a causal event, and the system determines that the one hundred PDB events are symptom events. In this example, the system generates a compression policy that compresses the one hundred PDB failures into a single incident. Note that, in this example, a user may simply need to be notified of the CDB failure event to resolve the CDB failure and the PDB failures; notifying the user of the PDB failure events may obfuscate the CDB failure event. Additionally, or alternatively, the system, based on a root cause analysis, refrains from determining a candidate compression policy for a cluster of uncompressed events. For example, if a root cause analysis targeting multiple events does not indicate that the multiple similar derive from a common cause, the system may refrain from determining a candidate compression policy that would compress the multiple events into a single incident. Note that a root cause analysis may be employed in a similar manner while generating a decompression policy. For example, if the system identifies a causal event in a cluster of related uncompressed events, the system may formulate a decompression policy that is designed to ensure the causal event is not obscured as a result of the causal event being compressed into an incident with the other related events.

The system, according to an embodiment, generates a candidate compression policy by applying machine learning model(s). Additional embodiments and/or examples relating to using machine learning to generate a candidate compression policy are described below in Section 5 titled “Machine Learning for Event Management.”

In an embodiment, the system simulates applying the candidate compression policy to the data corpus of event(s) (Operation 308). In particular, the system simulates applying the candidate compression policy to evaluate how the candidate compression policy would impact the generation of incidents, problems, and/or notifications. The system may simulate applying the candidate compression policy in combination with currently active compression policies, decompression policies, event rules, incident rules, problem rules, and/or other event processing mechanisms.

In an embodiment, the system presents the candidate compression policy to a user, and/or the system presents the results of the simulated application of the candidate compression policy to the user (Operation 310). The candidate compression policy and/or the results of the simulated application are presented to the user via an interface. In general, the results of the simulated application demonstrate how the candidate compression policy affects event processing. For example, the results of the simulated application may demonstrate changes to incident generation, changes to problem generation, changes to notification generation, and/or other changes to event processing that result from applying the candidate compression policy. The interface presents the candidate compression policy and/or the results of the simulated application using visualization(s), metric(s), natural language communication(s), and/or other communications.

Recall that the simulated application may entail applying the candidate compression policy in combination with other event processing mechanisms. Thus, the interface, according to an embodiment, presents communication(s) that indicate how events are processed by the candidate compression policy in combination with the other event processing mechanisms. The user may interact with the interface to enable and/or disable event processing mechanisms that are applied during the simulated application (e.g., the candidate compression policy or other event processing mechanisms). In response to a user interacting with the interface to activate or deactivate an event processing mechanism, the system updates communication(s) presented via the interface (e.g., visualizations, metrics, etc.) to demonstrate how the simulated application differs if that event processing mechanism is active or inactive.

The interface, according to an embodiment, presents a visualization that may include: (a) interface elements representing events, (b) interface elements representing incidents, (c) interface elements representing problems, (d) interface elements representing mappings between events, incidents, and problems, and/or (e) other interface elements. Based on the mappings between events and incidents, the user may discern how events are compressed as a result of the candidate compression policy and/or other event processing mechanisms. Furthermore, the user may interact with the interface elements to access additional information regarding the simulated application. For example, in response to the user interacting with an interface element representing an incident, the system may present to the user incident attributes, event attributes, target attributes, details of a compression policy or event rule that created the incident, and/or other information.

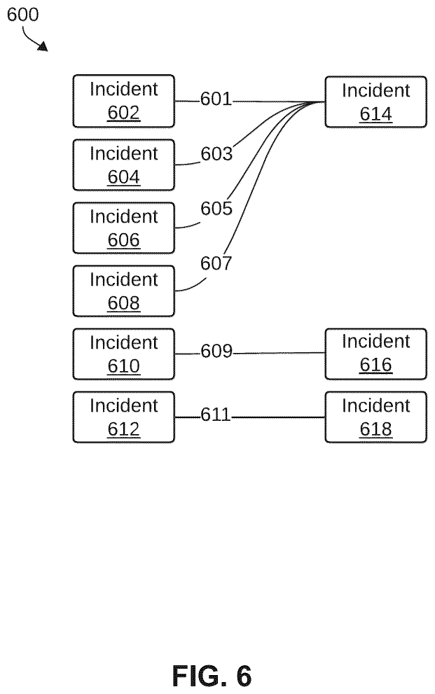

The interface, according to an embodiment, presents a visualization that depicts (a) how events are mapped to incidents without the candidate compression policy being enforced and (b) how events are compressed into incidents with candidate compression being enforced. An example visualization depicting incident generation with and without a candidate compression policy being active is described below with reference to FIG. 6.

The interface, according to an embodiment, presents metric(s) that describe the effectiveness of the candidate compression policy with respect to the simulated application. For example, the system may present metrics corresponding to (a) the number of events in the data corpus of events, (b) a number of incidents that are created without the candidate compression policy, (c) a number of incidents that are created with the candidate compression policy, (d) a relative proportion of fewer incidents that are created with the candidate compression policy, (e) a compression ratio of the candidate compression policy, and/or (f) other values characterizing the performance of the candidate compression policy during the simulated application.

The interface, according to an embodiment, presents natural language communications that describe the candidate compression policy. Additionally, or alternatively, the interface presents natural language communicates describing the results of the simulated application of the candidate compression policy. In an example, the system prompts a generative AI model to generate a natural language communication describing the performance of the candidate compression with respect to the simulated application, and the interface presents the resulting natural language communication to the user.

In an embodiment, the system obtains feedback from a user regarding the candidate compression policy (Operation 312). In particular, the system obtains feedback from the user in the form of user input that the system receives through the interface. Recall that the interface is presenting (a) the candidate compression policy and/or (b) the results of the simulated application of the candidate compression policy. Note that the system may interact with the interface in numerous ways. For instance, the user may interact with the interface to (a) navigate between communications, (b) access additional information, (c) modify how information is presented by the interface, (d) modify the candidate compression policy, (e) indicate approval of the candidate compression policy, (f) indicate disapproval of the candidate compression policy, (g) modify other event processing mechanisms, (h) generate new event processing mechanisms, and/or (i) perform various other actions. Any interaction with the user may serve as feedback to the system.

Recall that the interface may present a visualization that includes the following: (a) interface elements representing events, (b) interface elements representing incidents, (c) interface elements representing problems, (d) interface elements representing mappings between events, incidents, and problems, and/or (e) other interface elements. As such, the system, according to an embodiment, may obtain feedback when a user manipulates an interface element presented by the visualization. As an example, assume that the interface presents a user with a visualization depicting a cluster of events that are compressed into the same incident as a result of applying the candidate compression policy. In this example, the user provides feedback to the system by adding an event to the cluster of events, removing an event from the cluster of events, and/or otherwise interacting with the cluster of events.

The system, according to an embodiment, obtains feedback from the user passively, and/or the system obtains feedback from the user actively. In an example, the system obtains feedback passively by waiting for interactions from the user that may be processed to generate feedback. In another example, the system obtains feedback actively by querying the user for input that can be processed to generate feedback.

The system, according to an embodiment, obtains feedback through natural language input from a user. For instance, the interface may accept natural language input via tactile sensors (e.g., a keyboard), audio sensors, visual sensors, thermal sensors, and/or other sensors. The system may derive feedback from the natural language input by applying natural language processing to the natural language input.

The system, according to an embodiment, obtains feedback from a user by applying a generative AI model to interact with the user. For example, the system may prompt a generative AI model to formulate a query that is designed to elicit input from the user that can be processed to generate feedback. Furthermore, based on initial feedback that the system derives from the user's response to the query in this example, the system may further prompt the generative AI model to formulate additional queries that can be directed to the user in an effort to refine the initial feedback.

In an embodiment, the system determines if the feedback obtained from the user indicates approval of the candidate compression policy, and the system proceeds to another operation based on the determination (Operation 314). If the system determines that the feedback indicates approval of the candidate compression policy (YES in Operation 314), the system proceeds to Operation 318. Alternatively, if the system determines that feedback warrants modifying the candidate compression policy and/or other event processing mechanism(s) (NO in Operation 314), the system proceeds to Operation 316.

In an embodiment, the system updates the candidate compression policy based on the feedback obtained from the user (Operation 316). Additionally, or alternatively, the system generates and/or updates other event processing mechanism(s) based on the feedback obtained from the user. For example, the system may modify or generate another compression policy, decompression policy, event rule, incident rule, problem rule, or other event processing mechanism.

Recall that the interface, according to an embodiment, may present a visualization that includes (a) interface elements representing events, (b) interface elements representing incidents, (c) interface elements representing problems, (d) interface elements representing mappings between events, incidents, and problems, and/or (e) other interface elements. In this embodiment, the system may update the candidate compression policy based on the user manipulating interface element(s). As an example, assume that the user interacts with an interface element representing an event to remove that event from a cluster of events that are compressed into an incident as a result of the candidate compression policy. In this example, the system may (a) modify the candidate compression policy such that the event would not be compressed into that incident in the future, (b) generate and/or update a decompression policy such that the event would not be compressed into that incident in the future, and/or (c) modify other event processing mechanisms.

The system, according to an embodiment, updates communication(s) presented by the interface to reflect the modification to the candidate compression policy. Furthermore, the system updates the communication(s) presented by the interface to reflect any other changes to event processing mechanisms. For example, if user input modifies the candidate compression policy, the system may update a visualization of the simulated application of the candidate compression policy to reflect how the simulated application differs as a result of the modification.

In an embodiment, the system adds the candidate compression policy to the active event processing mechanisms (Operation 318). Having added the candidate compression policy to the active event processing mechanisms, the system will enforce the candidate compression policy against events that subsequently occur on target entities.

### 5. MACHINE LEARNING FOR EVENT MANAGEMENT

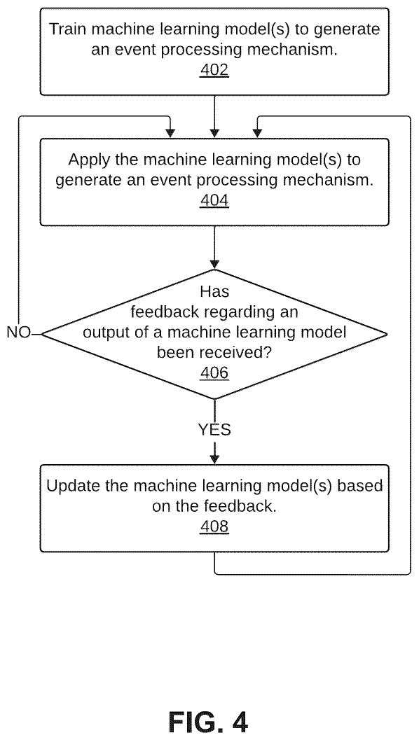

FIG. 4 illustrates an example set of operations for training machine learning model(s) to generate event processing mechanisms. One or more operations illustrated in FIG. 4 may be modified, rearranged, or omitted all together. Accordingly, the particular sequence of operations illustrated in FIG. 4 should not be construed as limiting the scope of one or more embodiments.

In an embodiment, the system trains machine learning model(s) to generate an event processing mechanism (Operation 402). The system trains a single machine learning model, or the system trains multiple machine learning models. More specifically, the machine learning model(s) are trained by machine learning algorithm(s) of a machine learning engine, and the machine learning model(s) are trained with training data. To train a machine learning model, a machine learning algorithm performs an iterative process of feeding training data to the machine learning model and adjusting the machine learning model's internal parameters to optimize the machine learning model's ability to identify patterns and relationships in the training data.

The machine learning engine, according to an embodiment, trains the machine learning model(s) to generate a compression policy, a decompression policy, an event rule, an incident rule, a problem rule, and/or another event processing mechanism. In an example, a machine learning model is trained to generate a candidate compression policy, and an example set of training data defines an association between (a) a cluster of related events and (b) a compression policy that is used to compress the cluster of events into an incident.

In an embodiment, the system applies the machine learning model(s) to generate an event processing mechanism that can be applied to a data corpus of events (Operation 404). The machine learning model(s) may generate the event processing mechanism based on various inputs. As an example, assume that a machine learning model is applied to generate a candidate compression policy. In this example, inputs that potentially influence the formulation of the candidate compression policy may include event attributes, target attributes, user characteristics, user input, and/or other information.

In an embodiment, the system determines if feedback regarding an output of the machine learning model(s) has been received, and the system proceeds to another operation based on the determination (Operation 406). If the system obtains feedback that relates to an output of a machine learning model (YES in Operation 406), the system proceeds to Operation 408. Alternatively, if the system does not obtain feedback pertaining to an output of a machine learning model (NO in Operation 406), the system returns to Operation 404.

In an embodiment, the system updates the machine learning model(s) based on any feedback the system obtains (Operation 408). To this end, the machine learning engine analyzes the feedback and generates additional training data based on the feedback. The machine learning engine analyzes feedback using a process of assimilating new data patterns, user interactions, and error trends into a data repository of the system. The machine learning engine uses this information to identify shifts in data trends or emergent patterns that were not present or were inadequately represented in the original training data. Based on this analysis, the machine learning engine initiates a retraining or updating cycle for the machine learning model(s). If feedback suggests minor deviations or incremental changes in data patterns, incremental learning strategies are employed to retrain the machine learning model(s). Incremental learning strategies are used for fine-tuning the machine learning model with the new data while retaining the machine learning model's previously learned knowledge. If feedback indicates significant shifts or the emergence of new patterns, a more comprehensive model updating process is initiated. This process might involve revisiting a machine learning model selection process, re-evaluating the suitability of the current model architecture, and/or potentially exploring alternative models or configurations that are more attuned to the new data. The machine learning engine tracks changes, modifications, and/or the evolution of the machine learning model(s) as result of further training based on feedback. Tracking changes, modifications, and evolution of the machine learning model(s) facilitates transparency into the integration of feedback and enables the machine learning model(s) to be rolled back to a previous state if appropriate.

### 6. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

### 6.1 Example Visualization of Event Processing

FIG. 5 illustrates a visualization 500 that may be presented by an interface in accordance with an example embodiment. As illustrated in FIG. 5, visualization 500 includes distinct interface elements for representing (a) events, (b) incidents, (c) problems, and (d) mappings between events, incidents, and problems. In an embodiment, visualization 500 may include more or fewer interface elements than the interface elements illustrated in FIG. 5, and operations described with respect to one interface element may instead be performed with respect to another interface element.

In an example embodiment, the system compresses event 502, event 504, event 506, and event 508 into incident 510. Accordingly, visualization 500 presents event 502, event 504, event 506, and event 508 as being represented by incident 510 via mapping 501, mapping 503, mapping 505, and mapping 507, respectively. The system compresses event 502, event 504, event 506, and event 508 into incident 510 pursuant to a compression policy, and/or the system compresses event 502, event 504, event 506, and event 508 into incident 510 pursuant to an event rule.

In an example embodiment, the system enforces an event rule that compresses event 512 and event 514 into incident 520. Accordingly, visualization 500 presents event 512 and event 514 as being represented by incident 520 via mapping 509 and mapping 511, respectively. The system compresses event 512 and event 514 into incident 520 pursuant to a compression policy, or the system compresses event 512 and event 514 into incident 520 pursuant to an event rule.

In an example embodiment, the system compresses event 516 and event 518 into incident 530. Accordingly, visualization 500 presents event 516 and event 518 as being represented by incident 530 via mapping 513 and mapping 515, respectively. The system compresses event 516 and event 518 into incident 530 pursuant to a compression policy, or the system compresses event 516 and event 518 into incident 530 pursuant to an event rule.

In an example embodiment, the system generates incident 540 to represent event 522. Accordingly, visualization 500 presents event 522 as being represented by incident 540 via mapping 517. The system generates incident 540 pursuant to an event rule that is applicable to event 522.

In an example embodiment, the system generates incident 550 to represent event 524. Accordingly, visualization 500 presents event 524 as being represented by incident 550 via mapping 519. The system generates incident 550 pursuant to an event rule that is applicable to event 524.

In an example embodiment, the system compresses incident 510 and incident 520 into problem 560. Accordingly, visualization 500 presents incident 510 and incident 520 as being represented by problem 560 via mapping 521 and mapping 523, respectively. The system compresses incident 510 and incident 520 into problem 560 pursuant to an incident rule that is applicable incident 510 and incident 520. Note that the example depicted by FIG. 5 may correspond to the system concluding that event 502, event 504, event 506, event 508, event 512, and event 514 are collectively associated with a same issue.

In an example embodiment, the system generates problem 570 to represent incident 530. Accordingly, visualization 500 presents incident 530 as being represented by problem 570 via mapping 525. The system generates problem 570 pursuant to an incident rule that is applicable to incident 530. Note that the example depicted by FIG. 5 may correspond to the system concluding that event 516 are event 518 are both associated with the same issue.

In an example embodiment, the system generates problem 580 to represent incident 540. Accordingly, visualization 500 presents incident 540 as being represented by problem 580 via mapping 527. The system generates problem 580 pursuant to an incident rule that is applicable to incident 540.

In an example embodiment, the system generates problem 590 to represent incident 550. Accordingly, visualization 500 presents incident 550 as being represented by problem 590 via mapping 529. The system generates problem 590 pursuant to an incident rule that is applicable to incident 550.

In an example embodiment, the interface receives user input that enables a compression policy, a decompression policy, an event rule, an incident rule, or another event processing mechanism. In response, the system updates visualization 500 to reflect the changes to event processing that result from enabling the event processing mechanism.

In an example embodiment, the interface receives user input that disables a compression policy, a decompression policy, an event rule, an incident rule, or another event processing mechanism. In response, the system updates visualization 500 to reflect the changes to event processing that result from disabling the event processing mechanism.

In an example embodiment, the interface receives user input that interacts with an interface element of visualization 500 corresponding to an event, incident, or problem. In response, the system presents the user with additional information regarding that event, incident, or problem. As an example, assume that a user interacts with event 502. In this example, the system presents the user with attributes of event 502.

In an example embodiment, the interface receives user input that interacts with a mapping included within visualization 500. In response, the system presents the user with additional information regarding the event processing mechanism represented by the mapping. As an example, assume that a user interacts with mapping 501. In this example, the system presents the user with additional information regarding the compression policy or event rule that resulted in event 502 being compressed into incident 510.

In an example embodiment, the interface receives user input that manipulates visualization 500. In particular, the user input manipulates event 508 and/or mapping 507 to remove event 508 from the cluster of events that are being compressed into incident 510. In response, the system may (a) generate a new incident to represent event 508, (b) update a compression policy such that event 508 would not be compressed into incident 510 in the future, (c) update an event rule such that event 508 would not be compressed into incident 510 in the future, (d) generate and/or update a decompression policy that would decompress event 508 from incident 510 in the future, and/or (e) modify other event processing mechanisms. Furthermore, if event processing mechanisms are generated by applying machine learning model(s), the user input manipulating visualization 500 is utilized to generate feedback for the machine learning model(s).

In an example embodiment, the interface receives user input that manipulates visualization 500. In particular, the user input manipulates event 522 and/or mapping 517 to add event 522 to the cluster of events that are being compressed into incident 540. In response, the system may (a) update a compression policy such that event 522 would be compressed into incident 540 in the future, (b) update an event rule such that event 522 would be compressed into incident 540 in the future, (c) update or delete a decompression policy that decompresses event 522 from incident 540 in the future, and/or (d) modify other event processing mechanisms. Furthermore, if event processing mechanisms are generated by applying machine learning model(s), the user input manipulating visualization 500 is utilized to generate feedback for the machine learning model(s).

In an example embodiment, the interface receives user input that manipulates visualization 500. In particular, the user input manipulates event 524 and/or mapping 519 to add event 524 to a cluster of events that are being compressed into incident 550. In response, the system may (a) generate a new compression policy that would compress event 522 and event 524 into incident 550, (b) generate a new event rule that would compress event 522 and event 524 into incident 550, (c) update or delete any decompression policy that would decompress event 522 and/or event 524 from incident 550, and/or (d) modify other event processing mechanisms. Furthermore, if event processing mechanisms are generated by applying machine learning model(s), the user input manipulating visualization 500 is utilized to generate feedback for the machine learning model(s).

In an example embodiment, the interface receives user input that manipulates visualization 500. In particular, the user input manipulates incident 520 and/or mapping 523 to remove incident 520 from problem 560. In response, the system may (a) update an incident rule such that incident 520 would not be compressed into problem 560 in the future, and/or (b) modify other event processing mechanisms. Furthermore, if event processing mechanisms are generated by applying machine learning model(s), the user input manipulating visualization 500 is utilized to generate feedback for the machine learning model(s).

In an example embodiment, the interface receives user input that manipulates visualization 500. In particular, the user input manipulates incident 530 and/or mapping 525 to add incident 530 to the group of incidents that are compressed into problem 560 rather than problem 570. In response, the system may (a) update an incident rule such that incident 530 would be compressed into problem 560 rather than problem 570 in the future and/or (b) modify other event processing mechanisms. Furthermore, if event processing mechanisms are generated by applying machine learning model(s), the user input manipulating visualization 500 is utilized to generate feedback for the machine learning model(s).

### 6.2 Example Visualization of Event Compression

FIG. 6 illustrates a visualization 600 that may be presented by an interface in accordance with an example embodiment. As illustrated in FIG. 6, visualization 600 includes distinct interface elements for events and incidents. Note that in the example depicted by FIG. 6, incidents are represented by rectangular interface elements, and events are represented by linear interface elements. In an embodiment, visualization 600 may include more or fewer interface elements than the interface illustrated in FIG. 6, and operations described with respect to one interface element may instead be performed with respect to another interface element.

In an example embodiment, visualization 600 depicts incidents that are generated if a candidate compression policy is not applied to a data corpus of events, and visualization 600 depicts incidents that are generated if the candidate compression policy is applied to a data corpus of events. In particular, visualization 600 indicates that, if the candidate compression policy is not applied (a) incident 602 is generated to represent event 601, (b) incident 604 is generated to represent event 603, (c) incident 606 is generated to represent event 605, (d) incident 608 is generated to represent event 607, (e) incident 610 is generated to represent event 609, and (f) incident 612 is generated to represent event 611. Furthermore, visualization 600 indicates that, if the candidate compression policy is applied (a) event 601, event 603, event 605, and event 607 are compressed into incident 614, (b) incident 616 is generated to represent event 609, and (c) incident 618 is generated to represent event 611.

In an example embodiment, the interface receives user input that interacts with an interface element of visualization 600 corresponding to an event. In response, the system presents the user with additional information regarding that event. As an example, assume that a user interacts with event 601. In this example, the system presents the user with attributes of event 601.

In an example embodiment, the interface receives user input that interacts with an interface element of visualization 600 corresponding to an incident. In response, the system presents the user with additional information regarding that incident. As an example, assume that a user interacts with incident 614. In this example, the system presents the user with attributes of incident 614, and/or the system presents the user with additional information regarding the candidate compression policy that compresses event 601, event 603, event 605, and event 607 into incident 614.

In an example embodiment, the interface receives user input that interacts with a mapping included within visualization 600, and, in response, the system presents the user with additional information regarding the event processing mechanism represented by the mapping. As an example, assume that a user interacts with mapping 601. In this example, the system presents the user with additional information regarding the compression policy or event rule that resulted in event 602 being compressed into incident 610.

In an example embodiment, the interface receives user input that manipulates visualization 600. In particular, the user input interacts with event 607 to remove event 607 from the cluster of events that are being compressed into incident 614. In response, the system (a) updates a candidate compression policy such that event 608 would not be compressed into incident 610, (b) generates and/or updates a decompression policy that would decompress event 608 from incident 610, and/or (c) alters other event processing mechanisms. Furthermore, if compression policies and/or decompression polices are generated by applying machine learning model(s), the user input manipulating visualization 600 is utilized to generate feedback for the machine learning model(s).

In an example embodiment, the interface receives user input that manipulates visualization 600. In particular, the user input manipulates event 609 to add event 609 to the cluster of events that are being compressed into incident 614. In response, the system (a) updates the candidate compression policy such that event 609 would be compressed into incident 614, (b) updates or deletes a decompression policy that might otherwise prevent the candidate compression policy from compressing event 609 into incident 614 (e.g., by decompressing event 609 from incident 614), and/or (c) alters other event processing mechanisms. Furthermore, if compression policies and/or decompression polices are generated by applying machine learning model(s), the user input manipulating visualization 600 is utilized to generate feedback for the machine learning model(s). Note that in this example embodiment, if a subsequent simulated application of the candidate compression policy is performed, event 609 would be compressed into incident 614 rather than incident 616, and incident 616 would not be generated.

In an example embodiment, the interface receives user input that manipulates visualization 600. In particular, the user input manipulates event 611 to add event 611 to a cluster of events that are being compressed into incident 616. In response, the system (a) generates a new candidate compression policy that would compress event 609 and event 611 into incident 616, (b) updates or deletes any decompression policy that would otherwise decompress event 609 and/or event 611 from incident 616, and/or (c) alters other event processing mechanisms. Furthermore, if compression policies and/or decompression polices are generated by applying machine learning model(s), the user input manipulating visualization 600 is utilized to generate feedback for the machine learning model(s). Note that in this example embodiment, if a subsequent simulated application of the candidate compression policy is performed, event 609 and event 611 would be compressed into incident 616, and incident 618 would not be generated.

### 6.3 Example Visualization of a Compression Policy Analysis

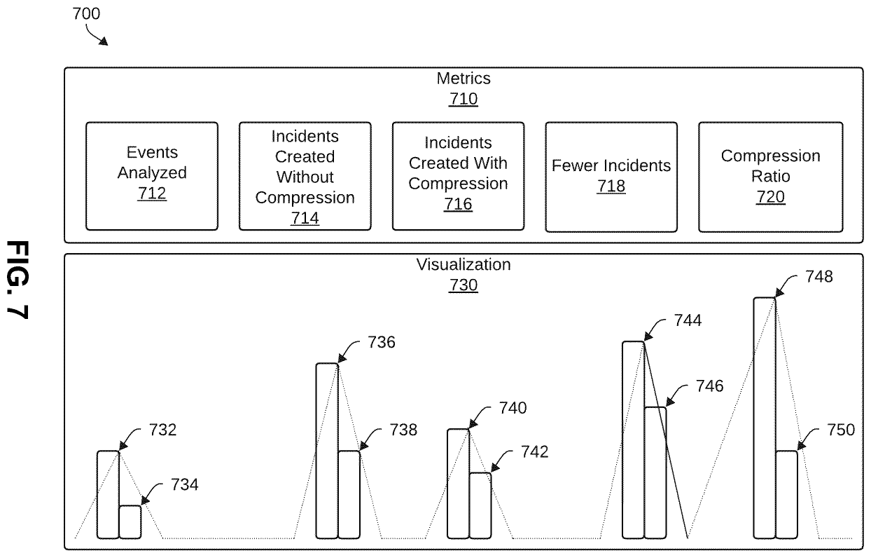

FIG. 7 illustrates a dashboard 700 that may be presented by an interface in accordance with an example embodiment. As illustrated in FIG. 7, dashboard 700 includes interface elements representing incidents, and dashboard 700 includes interface elements representing metrics. In an embodiment, dashboard 700 may include more or fewer interface elements than the interface elements illustrated in FIG. 7, and operations described with respect to one interface element may instead be performed with respect to another interface element.

In an example embodiment, the system generates dashboard 700 to demonstrate the performance of a group of candidate compression policies during a simulated application of the group of candidate compression policies. The simulated application involves a data corpus of events that occur in a computing environment over a set period of time. The set period of time is determined by the system, or the set period of time is determined by a user. As illustrated in FIG. 7, dashboard 700 includes metrics 710 and visualization 730.

In an example embodiment, metrics 710 characterize the performance of the group of candidate compression policies during the simulated application. As illustrated in FIG. 7, metrics 710 include events analyzed 712, incidents created without compression 714, incidents created with compression 716, fewer incidents 718, and compression ratio 720.

In an example embodiment, events analyzed 712 is a numerical value corresponding to the number events that are recorded during the set period of time. Events analyzed 712 represents the total number of events that the group of candidate compression policies are applied to during the simulated application.

In an example embodiment, incidents created without compression 714 is a numerical value corresponding to the incidents that are generated during the set time period without the group of candidate compression policies being active.

In an example embodiment, incidents created with compression 716 is a numerical value corresponding to the incidents that are created during the set time period if the group of candidate compression polices are active.

In an example embodiment, fewer incidents 718 is a numerical value corresponding to the relative reduction in incidents that is realized if the group of candidate compression policies are active during the set period of time.

In an example embodiment, compression ratio 720 is a numerical value corresponding to the average number of events that are compressed per incident if the group of candidate compression policies are active during the set time period.

In an example embodiment, visualization 730 characterizes the performance of the group of candidate compression policies during the simulated application. As illustrated in FIG. 7, visualization 700 includes bar 732, bar 734, bar 736, bar 738, bar 740, bar 742, bar 744, bar 746, bar 748, and bar 750.

In an example embodiment, bar 732 represents the number of incidents that are generated on a first date without the group of candidate compression policies being active, and bar 734 represents the number of incidents that are generated on the first date if the group of candidate compression policies are active.

In an example embodiment, bar 736 represents the number of incidents that are generated on a second date without the group of candidate compression policies being active, and bar 738 represents the number of incidents that are generated on the second date if the group of candidate compression policies are active.

In an example embodiment, bar 740 represents the number of incidents that are generated on a third date without the group of candidate compression policies being active, and bar 742 represents the number of incidents that are generated on the third date if the group of candidate compression policies are active.

In an example embodiment, bar 744 represents the number of incidents that are generated on a fourth date without the group of candidate compression policies being active, and bar 746 represents the number of incidents that are generated on the fourth date if the group of candidate compression policies are active.

In an example embodiment, bar 748 represents the number of incidents that are generated on a fifth date without the group of candidate compression policies being active, and bar 750 represents the number of incidents that are generated on the fifth date if the group of candidate compression policies are active.

### 6.4 Example Implementations

This Section 6.4 describes example implementations of techniques described herein in accordance with an example embodiment. In one or more embodiments, one or more operations described below are modified, rearranged or omitted altogether, and it should be understood that the particular sequence of operations described below should not be construed as limiting the scope of one or more embodiments. Furthermore, one or more embodiments may include more or fewer components than the components described below, and/or one or more components described below may be modified, rearranged, or omitted altogether.

In an example embodiment, one or more non-transitory computer-readable media comprise instructions that, when executed by one or more hardware processors, cause performance of operations comprising: identifying a plurality of events detected by a system; applying a set of one or more compression policies to the plurality of events to compute a plurality of incidents, wherein two or more events in the plurality of events are represented by a single compressed incident in the plurality of incidents; displaying, on a Graphical User Interface (GUI), a first plurality of interface elements corresponding to the plurality of events; displaying, on the GUI, a second plurality of interface elements corresponding to the plurality of incidents; and displaying, on the GUI, a third plurality of interface elements that maps the plurality of events to the plurality of incidents, wherein the two or more events are mapped to the single compressed incident by a set of one or more interface elements in the third plurality of interface elements.

In an example embodiment, the operations executed by the one or more hardware processors further comprise: identifying a first event of the plurality of events that (a) is not compressed by application of the set of one or more compression policies and (b) corresponds to a first incident of the plurality of incidents, wherein (a) the first incident is mapped to the first event and (b) the first incident is not mapped to a second event; identifying a candidate compression policy, not included in the set of one or more compression policies, that would result in compression of (a) the first event of the plurality of events and a second event of the plurality of events into (b) the first incident of the plurality of incidents; and presenting the candidate compression policy for user evaluation.

In an example embodiment, an interface element, of the third plurality of interface elements, identifies a particular compression policy of the set of one or more compression policies that resulted in compression of the two or more events in the plurality of events into the single compressed incident in the plurality of incidents.

In an example embodiment, the operations executed by the one or more hardware processors further comprise: computing a first metric, the first metric corresponding to a number of events that are compressed by applying the set of one or more compression policies; identifying a particular number of events that are compressed by applying a particular compression policy of the set of one or more compression policies; computing a second metric, the second metric corresponding to a relative contribution of the particular number to the first metric; and displaying, on the GUI, an interface element representing the second metric.

In an example embodiment, the two or more events in the plurality of events form a compression group, and the operations executed by the one or more hardware processors further comprise: receiving user input removing a first event from the compression group; responsive to receiving the user input: identifying a particular compression policy, of the set of one or more compression policies, that resulted in compression of the first event into the single compressed incident; removing the particular compression policy from the set of one or more compression policies to generate an updated set of one or more compression policies that are being applied to determine the plurality of incidents; and updating the plurality of incidents based on the updated set of one or more compression policies.

In an example embodiment, the operations executed by the one or more hardware processors further comprise: prior to updating the plurality of incidents based on the updated set of one or more compression policies: adding one or more additional compression policies to the updated set of one or more compression policies.

In an example embodiment, the two or more events in the plurality of events form a compression group, applying the set of one or more compression policies comprises applying a machine learning model to the plurality of events, and the operations executed by the one or more hardware processors further comprise: receiving user input removing a first event from the compression group; responsive to receiving the user input: generating feedback for the machine learning model; updating the machine learning model based on the feedback; and applying the updated machine learning model to the plurality of events to determine an updated plurality of incidents.

In an example embodiment, the two or more events in the plurality of events form a compression group, and the operations executed by the one or more hardware processors further comprise: prior to applying the set of one or more compression policies: determining that a first event of the plurality of events corresponds to a root cause of one or more events of the plurality of events; and selecting the set of one or more compression policies for application to the plurality of events at least in part on a basis that (a) the first event be excluded from the compression group and/or (b) the two or more events be included in the compression group.

In an example embodiment, the two or more events in the plurality of events form a compression group, and the operations executed by the one or more hardware processors further comprise: applying a set of one or more decompression policies to the plurality of events; and responsive to applying the set of one or more decompression policies: removing an event from the compression group.

In an example embodiment, one or more non-transitory computer-readable media comprise instructions that, when executed by one or more hardware processors, cause performance of operations comprising: identifying a plurality of events detected by a system; applying a first set of one or more event processing mechanisms to the plurality of events to compute a first plurality of incidents, wherein the first set of one or more event processing mechanisms does not comprise a particular compression policy; applying a second set of one or more event processing mechanisms to the plurality of events to compute a second plurality of incidents, the second set of one or more event processing mechanisms comprising the particular compression policy, wherein two or more events in the plurality of events are compressed by the particular compression policy into a single incident in the second plurality of incidents; displaying, on a Graphical User Interface (GUI), a first plurality of interface elements corresponding to the first plurality of incidents; displaying, on the GUI, a second plurality of interface elements corresponding to the second plurality of incidents; and displaying, on the GUI, a third plurality of interface elements that map the first plurality of incidents to the second plurality of incidents, wherein the third plurality of interface elements correspond to the plurality of events.

In an example embodiment, the operations further comprise: prior to applying the second set of one or more event processing mechanisms: identifying a first event of the plurality of events that (a) is not compressed by application of the first set of one or more event processing mechanisms and (b) corresponds to a first incident of the first plurality of incidents, wherein the (a) first incident is mapped to the first event and (b) the first incident is not mapped to a second event; and determining the particular compression policy to compress the first event, wherein the first event is comprised within the two or more events that are compressed into the single incident.

In an example embodiment, wherein the first plurality of interface elements comprises a first set of two or more interface elements, wherein the first set of two or more interface elements represents two or more incidents in the first plurality of incidents, wherein the single incident in the second plurality of incidents is represented by a second set of one or more interface elements in the second plurality of interface elements, wherein the two or more events in the plurality of events are represented by a third set of two or more interface elements in the third plurality of interface elements, and wherein the third set of two or more interface elements maps the first set of two or more interface elements to the second set of one or more interface elements.

In an example embodiment, the operations further comprise: computing a first metric, the first metric corresponding to a number of events that are compressed by applying the second set of one or more event processing mechanisms; identifying a particular number of events that are compressed by applying the particular compression policy of the second set of one or more event processing mechanisms; computing a second metric, the second metric corresponding to a relative contribution of the particular number to the first metric; and displaying, on the GUI, an interface element representing the second metric.

In an example embodiment, the two or more events of the plurality of events form a compression group, and the operations executed by the one or more hardware processors further comprise: receiving user input removing a first event from the compression group; responsive to receiving the user input: updating the particular compression policy of the second set of one or more event processing mechanisms to generate an updated second set of one or more event processing mechanisms that are being applied to determine the second plurality of incidents; and updating the second plurality of incidents based on the updated second set of one or more event processing mechanisms.

In an example embodiment, the operations executed by the one or more hardware processors further comprise: prior to updating the second plurality of incidents based on the updated second set of one or more event processing mechanisms: adding one or more additional event processing mechanisms to the updated second set of one or more event processing mechanisms.

In an example embodiment, the two or more events of the plurality of events form a compression group, and the operations executed by the one or more hardware processors further comprise: receiving user input adding a first event to the compression group; responsive to receiving the user input: based at, least in part, on the user input, updating the particular compression policy to generate an updated second set of one or more event processing mechanisms that are being applied to determine the second plurality of incidents; and updating the second plurality of incidents based on the updated set of one or more event processing mechanisms.

In an example embodiment, the two or more events of the plurality of events form a compression group, and the operations executed by the one or more hardware processors further comprise: formulating the particular compression policy, wherein formulating the particular compression policy comprises applying a machine learning model to the plurality of events; receiving user input removing a first event from the compression group; responsive to receiving the user input: generating feedback for the machine learning model; updating the machine learning model based on the feedback; and applying the updated machine learning model to the plurality of events to determine an updated second plurality of incidents.

In an example embodiment, the two or more events of the plurality of events form a compression group, and the operations executed by the one or more hardware processors further comprise: prior to applying the second set of one or more event processing mechanisms: determining that a first event of the plurality of events corresponds to a root cause of one or more events comprised within the plurality of events; and selecting the second set of one or more event processing mechanisms for application to the plurality of events at least in part on a basis that (a) the first event be excluded from the compression group and/or (b) the two or more events be included in the compression group.

In an example embodiment, the two or more events of the plurality of events form a compression group, and the operations executed by the one or more hardware processors further comprise: applying a set of one or more decompression policies to the plurality of events; and responsive to applying the set of one or more decompression policies: removing an event from the compression group.

In an example embodiment, a method is performed by at least one device including a hardware processor, and the method comprises: identifying a plurality of events detected by a system; applying a set of one or more compression policies to the plurality of events to compute a plurality of incidents, wherein two or more events in the plurality of events are represented by a single compressed incident in the plurality of incidents; displaying, on a Graphical User Interface (GUI), a first plurality of interface elements corresponding to the plurality of events; displaying, on the GUI, a second plurality of interface elements corresponding to the plurality of incidents; and displaying, on the GUI, a third plurality of interface elements that maps the plurality of events to the plurality of incidents, wherein the two or more events are mapped to the single compressed incident by a set of one or more interface elements in the third plurality of interface elements.

In an example embodiment, a method is performed by at least one device including a hardware processor, and the method comprises: identifying a plurality of events detected by a system; applying a first set of one or more event processing mechanisms to the plurality of events to compute a first plurality of incidents, wherein the first set of one or more event processing mechanisms does not comprise a particular compression policy; applying a second set of one or more event processing mechanisms to the plurality of events to compute a second plurality of incidents, the second set of one or more event processing mechanisms comprising the particular compression policy, wherein two or more events in the plurality of events are compressed by the particular compression policy into a single incident in the second plurality of incidents; displaying, on a Graphical User Interface (GUI), a first plurality of interface elements corresponding to the first plurality of incidents; displaying, on the GUI, a second plurality of interface elements corresponding to the second plurality of incidents; and displaying, on the GUI, a third plurality of interface elements that map the first plurality of incidents to the second plurality of incidents, wherein the third plurality of interface elements correspond to the plurality of events.

In an example embodiment, a system comprises at least one device including a hardware processor, and the system is configured to perform operations comprising: identifying a plurality of events detected by a system; applying a set of one or more compression policies to the plurality of events to compute a plurality of incidents, wherein two or more events in the plurality of events are represented by a single compressed incident in the plurality of incidents; displaying, on a Graphical User Interface (GUI), a first plurality of interface elements corresponding to the plurality of events; displaying, on the GUI, a second plurality of interface elements corresponding to the plurality of incidents; and displaying, on the GUI, a third plurality of interface elements that maps the plurality of events to the plurality of incidents, wherein the two or more events are mapped to the single compressed incident by a set of one or more interface elements in the third plurality of interface elements.

In an example embodiment, a system comprises at least one device including a hardware processor, and the system is configured to perform operations comprising: identifying a plurality of events detected by a system; applying a first set of one or more event processing mechanisms to the plurality of events to compute a first plurality of incidents, wherein the first set of one or more event processing mechanisms does not comprise a particular compression policy; applying a second set of one or more event processing mechanisms to the plurality of events to compute a second plurality of incidents, the second set of one or more event processing mechanisms comprising the particular compression policy, wherein two or more events in the plurality of events are compressed by the particular compression policy into a single incident in the second plurality of incidents; displaying, on a Graphical User Interface (GUI), a first plurality of interface elements corresponding to the first plurality of incidents; displaying, on the GUI, a second plurality of interface elements corresponding to the second plurality of incidents; and displaying, on the GUI, a third plurality of interface elements that map the first plurality of incidents to the second plurality of incidents, wherein the third plurality of interface elements correspond to the plurality of events.

### 7. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, the database may be shared by multiple tenants.

In an embodiment, a subscription list indicates the applications that the different tenants have authorization to access. For each application, a list of tenant IDs of tenants authorized to access the application is stored. A tenant is permitted access to a particular application if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8 MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications that are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### 8.1 Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information pertaining to the satisfied trigger condition. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 8.2 Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 9. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

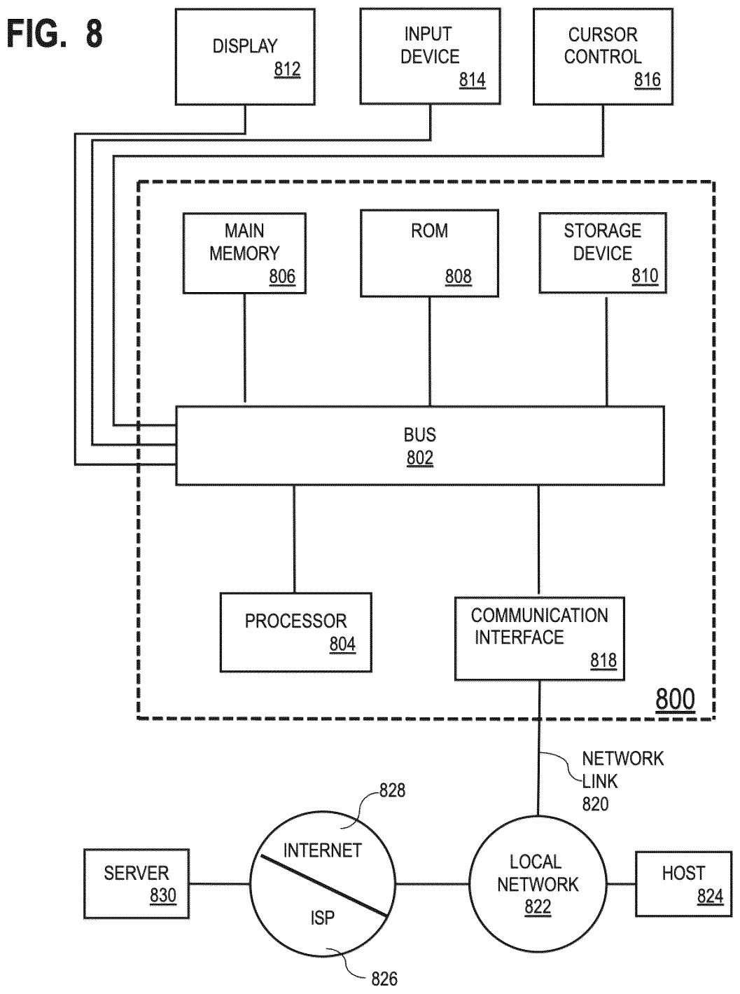

For example, FIG. 8 is a block diagram that illustrates a computer system 800 that an embodiment of the disclosure may be implemented upon. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or a Solid State Drive (SSD) is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic that in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806. Processor 804 retrieves and executes the instructions from main memory 806. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, that carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as the received code is received, and/or stored in storage device 810, or other non-volatile storage for later execution.

### 10. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form that such claims issue, including any subsequent correction.

1. (canceled)

2. (canceled)

3. (canceled)

4. (canceled)

5. (canceled)

6. One or more non-transitory computer-readable media comprising instructions that, when executed by one or more hardware processors, cause performance of operations comprising:
identifying a plurality of events detected by a system;
applying a set of one or more compression policies to the plurality of events to compute a plurality of incidents, wherein two or more events in the plurality of events are represented by a single compressed incident in the plurality of incidents;
displaying, on a Graphical User Interface (GUI), a first plurality of interface elements corresponding to the plurality of events;
displaying, on the GUI, a second plurality of interface elements corresponding to the plurality of incidents; and
displaying, on the GUI, a third plurality of interface elements that maps the plurality of events to the plurality of incidents, wherein the two or more events are mapped to the single compressed incident by a set of one or more interface elements in the third plurality of interface elements.

7. The one or more non-transitory computer-readable media of claim 1, wherein the operations further comprise:
identifying a first event of the plurality of events that (a) is not compressed by application of the set of one or more compression policies and (b) corresponds to a first incident of the plurality of incidents, wherein (a) the first incident is mapped to the first event and (b) the first incident is not mapped to a second event;
identifying a candidate compression policy, not included in the set of one or more compression policies, that would result in compression of (a) the first event of the plurality of events and a second event of the plurality of events into (b) the first incident of the plurality of incidents; and
presenting the candidate compression policy for user evaluation.

8. The one or more non-transitory computer-readable media of claim 1, wherein an interface element, of the third plurality of interface elements, identifies a particular compression policy of the set of one or more compression policies that resulted in compression of the two or more events in the plurality of events into the single compressed incident in the plurality of incidents.

9. The non-transitory computer-readable media of claim 1, wherein the operations further comprise:
computing a first metric, the first metric corresponding to a number of events that are compressed by applying the set of one or more compression policies;
identifying a particular number of events that are compressed by applying a particular compression policy of the set of one or more compression policies;
computing a second metric, the second metric corresponding to a relative contribution of the particular number to the first metric; and
displaying, on the GUI, an interface element representing the second metric.

10. The one or more non-transitory computer-readable media of claim 1, wherein the two or more events of the plurality of events form a compression group, and
wherein the operations further comprise:
receiving user input removing a first event from the compression group;
responsive to receiving the user input:
identifying a particular compression policy, of the set of one or more compression policies, that resulted in compression of the first event into the single compressed incident;
removing the particular compression policy from the set of one or more compression policies to generate an updated set of one or more compression policies that are being applied to determine the plurality of incidents; and
updating the plurality of incidents based on the updated set of one or more compression policies.

11. The one or more non-transitory computer-readable media of claim 5, wherein further responsive to receiving the user input:
prior to updating the plurality of incidents based on the updated set of one or more compression policies:
adding one or more additional compression policies to the updated set of one or more compression policies.

12. The one or more non-transitory computer-readable media of claim 1, wherein the two or more events in the plurality of events form a compression group, wherein applying the set of one or more compression policies comprises applying a machine learning model to the plurality of events, and wherein the operations further comprise:
receiving user input removing a first event from the compression group;
responsive to receiving the user input:
generating feedback for the machine learning model;
updating the machine learning model based on the feedback; and
applying the updated machine learning model to the plurality of events to determine an updated plurality of incidents.

13. The one or more non-transitory computer-readable media of claim 1, wherein the two or more events in the plurality of events form a compression group, and
wherein the operations further comprise:
prior to applying the set of one or more compression policies:
determining that a first event of the plurality of events corresponds to a root cause of one or more events of the plurality of events; and
selecting the set of one or more compression policies for application to the plurality of events at least in part on a basis that (a) the first event be excluded from the compression group and/or (b) the two or more events be included in the compression group.

14. The one or more non-transitory computer-readable media of claim 1, wherein the two or more events in the plurality of events form a compression group, and
wherein the operations further comprise:
applying a set of one or more decompression policies to the plurality of events; and
responsive to applying the set of one or more decompression policies:
removing an event from the compression group.

15. One or more non-transitory computer-readable media comprising instructions that, when executed by one or more hardware processors, cause performance of operations comprising:
identifying a plurality of events detected by a system;
applying a first set of one or more event processing mechanisms to the plurality of events to compute a first plurality of incidents, wherein the first set of one or more event processing mechanisms does not comprise a particular compression policy;
applying a second set of one or more event processing mechanisms to the plurality of events to compute a second plurality of incidents, the second set of one or more event processing mechanisms comprising the particular compression policy, wherein two or more events in the plurality of events are compressed by the particular compression policy into a single incident in the second plurality of incidents;
displaying, on a Graphical User Interface (GUI), a first plurality of interface elements corresponding to the first plurality of incidents;
displaying, on the GUI, a second plurality of interface elements corresponding to the second plurality of incidents; and
displaying, on the GUI, a third plurality of interface elements that map the first plurality of incidents to the second plurality of incidents, wherein the third plurality of interface elements correspond to the plurality of events.

16. The one or more non-transitory computer-readable media of claim 10,
wherein the operations further comprise:
prior to applying the second set of one or more event processing mechanisms:
identifying a first event of the plurality of events that (a) is not compressed by application of the first set of one or more event processing mechanisms and (b) corresponds to a first incident of the first plurality of incidents, wherein the (a) first incident is mapped to the first event and (b) the first incident is not mapped to a second event; and
determining the particular compression policy to compress the first event, wherein the first event is comprised within the two or more events that are compressed into the single incident.

17. The one or more non-transitory computer-readable media of claim 10,
wherein the first plurality of interface elements comprises a first set of two or more interface elements, wherein the first set of two or more interface elements represents two or more incidents in the first plurality of incidents, wherein the single incident in the second plurality of incidents is represented by a second set of one or more interface elements in the second plurality of interface elements, wherein the two or more events in the plurality of events are represented by a third set of two or more interface elements in the third plurality of interface elements, and wherein the third set of two or more interface elements maps the first set of two or more interface elements to the second set of one or more interface elements.

18. The one or more non-transitory computer-readable media of claim 10,
wherein the operations further comprise:
computing a first metric, the first metric corresponding to a number of events that are compressed by applying the second set of one or more event processing mechanisms;
identifying a particular number of events that are compressed by applying the particular compression policy of the second set of one or more event processing mechanisms;
computing a second metric, the second metric corresponding to a relative contribution of the particular number to the first metric; and
displaying, on the GUI, an interface element representing the second metric.

19. The one or more non-transitory computer-readable media of claim 10,
wherein the two or more events of the plurality of events form a compression group, and wherein the operations further comprise:
receiving user input removing a first event from the compression group;
responsive to receiving the user input:
updating the particular compression policy of the second set of one or more event processing mechanisms to generate an updated second set of one or more event processing mechanisms that are being applied to determine the second plurality of incidents; and
updating the second plurality of incidents based on the updated second set of one or more event processing mechanisms.

20. The one or more non-transitory computer-readable media of claim 14,
wherein further responsive to receiving the user input:
prior to updating the second plurality of incidents based on the updated second set of one or more event processing mechanisms:
adding one or more additional event processing mechanisms to the updated second set of one or more event processing mechanisms.

21. The one or more non-transitory computer-readable media of claim 10,
wherein the two or more events of the plurality of events form a compression group, and wherein the operations further comprise:
receiving user input adding a first event to the compression group;
responsive to receiving the user input:
based at, least in part, on the user input, updating the particular compression policy to generate an updated second set of one or more event processing mechanisms that are being applied to determine the second plurality of incidents; and
updating the second plurality of incidents based on the updated set of one or more event processing mechanisms.

22. The one or more non-transitory computer-readable media of claim 10,
wherein the two or more events in the plurality of events form a compression group, and wherein the operations further comprise:
formulating the particular compression policy, wherein formulating the particular compression policy comprises applying a machine learning model to the plurality of events;
receiving user input removing a first event from the compression group;
responsive to receiving the user input:
generating feedback for the machine learning model;
updating the machine learning model based on the feedback; and
applying the updated machine learning model to the plurality of events to determine an updated second plurality of incidents.

23. The one or more non-transitory computer-readable media of claim 10,
wherein the two or more events in the plurality of events form a compression group, and wherein the operations further comprise:
prior to applying the second set of one or more event processing mechanisms:
determining that a first event of the plurality of events corresponds to a root cause of one or more events comprised within the plurality of events; and
selecting the second set of one or more event processing mechanisms for application to the plurality of events at least in part on a basis that (a) the first event be excluded from the compression group and/or (b) the two or more events be included in the compression group.

24. The one or more non-transitory computer-readable media of claim 10,
wherein the two or more events in the plurality of events form a compression group, and wherein the operations further comprise:
applying a set of one or more decompression policies to the plurality of events; and
responsive to applying the set of one or more decompression policies:
removing an event from the compression group.

25. A method comprising:
identifying a plurality of events detected by a system;
applying a set of one or more compression policies to the plurality of events to compute a plurality of incidents, wherein two or more events in the plurality of events are represented by a single compressed incident in the plurality of incidents;
displaying, on a Graphical User Interface (GUI), a first plurality of interface elements corresponding to the plurality of events;
displaying, on the GUI, a second plurality of interface elements corresponding to the plurality of incidents; and
displaying, on the GUI, a third plurality of interface elements that maps the plurality of events to the plurality of incidents, wherein the two or more events are mapped to the single compressed incident by a set of one or more interface elements in the third plurality of interface elements;
wherein the method is performed by at least one device including a hardware processor.
